(19) United States
(12) Patent Application Publication
(10) Pub. No.: US 2003/0151150 A1
(43) Pub. Date: Aug. 14, 2003

(54) Method for manufacturing disc-shaped optical recording medium

(76) Inventors: Tomoki Ushida, Tokyo (JP); Mamoru Usami, Tokyo (JP)

Correspondence Address: RADER, FISHMAN & GRAUER PLLC, David T. Nikaido, Suite 501, 1233 20th Street, N.W., Washington, DC, 20036, US

(21) Appl. No.: 10/352,165

(22) Filed: Jan. 28, 2003

(30) Foreign Application Priority Data
Jan. 30, 2002 (JP) 2002-22195

(51) Int. Cl. B29D 17/00

(52) U.S. Cl. 264/1.33; 264/1.7; 264/2.7; 425/810

(57) ABSTRACT

A method for manufacturing a disc-shaped optical recording medium is provided, according to which a disc-shaped substrate with no central hole is accurately and stable positioned, when the substrate is spin-coated. A circular recess is formed in the center of a non-coated surface opposite to the surface to be coated of the disc-shaped substrate in the spin-coating step, and a ring-shaped raised rim to fit with the circular recess is provided on the side of a substrate holding portion supporting the disc-shaped substrate during spin-coating. The ring-shaped raised rim is fitted with the circular recess, so that the disc-shaped substrate is accurately positioned and held during the spin-coating step.

### DETAILED DESCRIPTION OF THE INVENTION

1. Field of the Invention

The present invention relates to a method for manufacturing a disc-shaped optical recording medium, especially a disc-shaped substrate to be formed into the disc-shaped optical recording medium.

2. Description of the Related Art

Disc-shaped optical recording media (optical discs) such as CD (Compact Disc) and DVD (Digital Versatile Disc) have a disc-shaped substrate produced by injection molding. In a prescribed region of the information recording surface of the disc-shaped substrate, a writable recording layer, a reflective layer provided to allow reproduction and the like are formed. A protection layer of resin is formed thereon to complete the disc-shaped optical recording media. A prescribed laser beam is irradiated through the disc-shaped substrate, so that information is recorded and/or reproduced.

Recently, another type of optical disc has been gaining attention. The disc is produced by a method as disclosed by Japanese Patent Laid-Open No. 8-235638, for example. According to the method, a support layer (protection layer) that does not have to transmit light, in other words, without optical thickness requirement is formed to be thick by injection molding as a disc-shaped substrate. Then, a reflective layer to allow reproduction, a writable recording layer and the like are formed on the information recording surface side of the substrate, and then a light transmitting layer of transparent resin that can transmit a laser beam for recording/reproducing is formed thereon.

According to a conventional method of manufacturing an optical disc, the center of the substrate as well as sprue runners solidified in the gate during injection molding is removed during the process, so that a circular central hole is formed in the center of the substrate, and then a reflective layer and a writable recording layer as described above are formed. Then, in the following process, a protection layer of resin, and a light transmitting layer of light transmitting resin are formed by spin-coating and thus the product is completed.

As disclosed by Japanese Patent Laid-Open Publication No. Hei. 10-249264, a feature of a method of manufacturing such a protection layer or light transmitting layer is that the central hole of the optical disc is covered with a lid member, over which resin is spread over the entire optical disc by spin-coating and cured, so that the protection layer (resin layer) is formed. According to the method, the thickness of the resin layer may readily be controlled within the coated plane so that the thickness is substantially equal in the radial direction. Therefore, the method is also applied to the process of forming the light transmitting layer as disclosed by Japanese Patent Laid-Open Publication No. Hei. 8-235638.

In order to apply this spin-coating method for the resin layer and form the resin layer to be in a more uniform state, a lid member to block the central hole of the substrate is necessary, and the lid member should be clean. When a single lid member is used, the lid must be cleaned after every use in resin coating. Alternatively, the lid member must be disposable, so that a new (clean) lid member is always used, which is inconvenient.

The inventors have therefore addressed to simplification of the process and yield improvement in forming the resin layer based on a different viewpoint from the above conventional technique using a lid member, and have invented a novel method for manufacturing a disc, according to which a central hole for optical disc chucking is formed after the resin layer is formed. They have also suggested a novel disc-shaped optical recording medium which has no central hole and in which the recording layer extends up to the region corresponding to the central hole. The method and medium are not yet publicly known.

When the substrate is spin-coated with the resin layer, however, the substrate must be positioned with respect to its center. Therefore, with no central hole for optical disc chucking, the substrate cannot be stably positioned and supported.

### SUMMARY OF THE INVENTION

The present invention is directed to a solution to the above described disadvantage, and it is an object of the present invention to provide a method for manufacturing a disc-shaped optical recording medium according to which a substrate can surely be positioned and held at the time of spin-coating. According to the method, one surface of a substrate is entirely coated with a resin layer by spin-coating, and a central hole for optical disc chucking is formed after the spin-coating process.

After intensive research, the inventors have found that the above-described disadvantage is solved by the use of a positioning guide having circular recesses on the non-coated surface of a disc-shaped substrate opposite to the surface to be coated by spin-coating in positioning during the spin-coating step.

In other words, the above-mentioned objectives are achievable by means of the present invention as follows.

(1) A method for manufacturing a disc-shaped optical recording medium, comprising the steps of: injection-molding a disc-shaped substrate without a central hole for optical recording medium chucking; and spin-coating a surface on one side of said disc-shaped substrate with resin, wherein forming a positioning guide on a non-coated surface opposite to said surface to be coated of the disc-shaped substrate in said injection-molding step, and positioning said disc-shaped substrate by said positioning guide in said spin-coating step.

(2) The method for manufacturing a disc-shaped optical recording medium according to (1), wherein in said injection-molding step, a circular recess is formed in the center of said disc-shaped substrate as said positioning guide, said recess having a depth not large enough to penetrate through the disc-shaped substrate in the thickness-wise direction.

(3) The method for manufacturing a disc-shaped optical recording medium according to (2), wherein said circular recess has a ring-shaped deep groove along the inner circumference, and the thickness of the substrate from the bottom of the deep groove to the coated surface of the substrate is in the range from 0.05 mm to 0.3 mm.

(4) The method for manufacturing a disc-shaped optical recording medium according to (2) or (3), further comprising perforating a region to be removed including at least a part of said circular recess in the center of said disc-shaped substrate, thereby forming a central hole for optical recording medium chucking after said spin-coating step.

(5) The method for manufacturing a disc-shaped optical recording medium according to (4), wherein said region to be removed has a diameter smaller than that of said circular recess and is present in the region of said circular recess.

(6) The method for manufacturing a disc-shaped optical recording medium according to (1) to (5), wherein until said spin-coating step is completed, said coated surface is continuous from the outer circumference to the center of said disc-shaped substrate, and no central hole is formed.

### BRIEF DESCRIPTION OF THE DRAWINGS

FIGS. 1A to 1D are perspective views for use in illustration of a method for manufacturing a disc-shaped optical recording medium according to an embodiment of the invention;

FIG. 2 is a perspective view of a substrate-holding portion for holding a disc-shaped substrate for use in a spin-coating step in the manufacturing method and the disc-shaped substrate;

FIG. 3 is an enlarged sectional view of a main part of the substrate holding portion and the disc-shaped substrate; and

FIGS. 4A and 4B are schematic perspective views of the disc-shaped substrate before and after a central hole is formed.

### DETAILED DESCRIPTION OF THE PREFERRED EMBODIMENTS

Now, an embodiment of the invention will be described in detail in conjunction with the accompanying drawings.

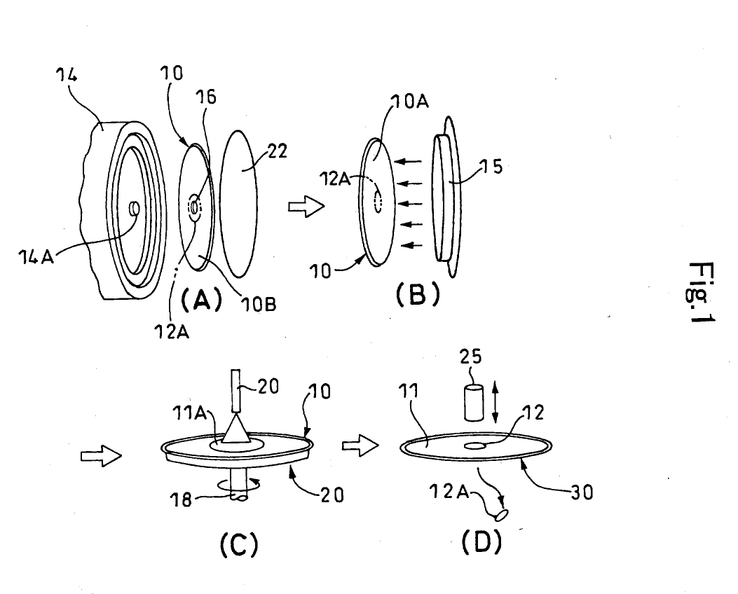

As shown in FIGS. 1A to 1D, the method for manufacturing a disc-shaped optical recording medium according to the embodiment includes the steps of injection molding a disc-shaped substrate 10 for an optical recording medium (see FIG. 1A), forming a writable recording layer, a reflective layer that allows reproduction and the like in a prescribed region of the information recording surface of the disc-shaped substrate 10 formed by the injection molding (see FIG. 1B), spin-coating a surface to be coated l0A (the information recording surface) with resin to form a light transmitting resin layer 11 (see FIG. 1C), and perforating a circular removal region 12A in the center of the disc-shaped substrate 10 with the light transmitting resin layer 11 formed thereon, thereby forming a central hole 12 for optical disc chucking (see FIG. 1D). The reference numeral 15 in FIG. 1B represents a target for sputtering and 30 in FIG. 1D represents a disc-shaped recording medium in its completed state.

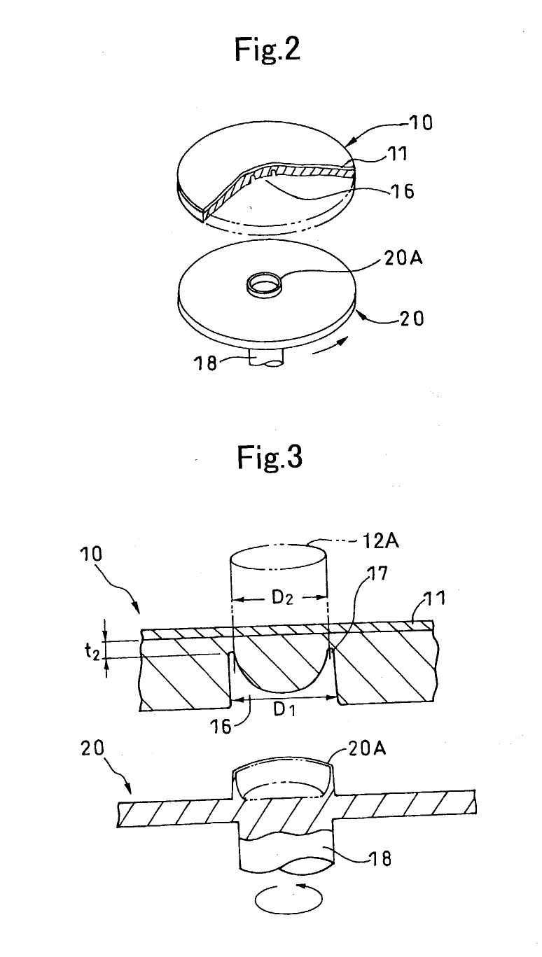

A mold 14 for injection molding includes a mold projection 14A for forming a circular recess 16 (see FIG. 2) not deep enough to penetrate in the thickness-wise direction through the disc-shaped substrate 10 in the center of the non-coated surface 10B opposite to the surface to be coated 10A of the disc-shaped substrate 10. The circular recess 16 has consists of a shallow central part and, a ring-shaped deep groove 17 surrounding the central part along the inner circumferential surface.

The circular recess 16 also plays an important role in the succeeding process of forming the main part of the central hole for chucking by perforating the central part corresponding to the bottom of the recess.

As shown in FIG. 3, the circular recess 16 in an approximately circular shape preferably has a diameter larger than that of the central hole 12 for optical disc chucking. This is because misfitting caused by contact between the perforation member (perforation edge) and the disc-shaped substrate 10 or burrs formed by perforation must be taken into account. The diameter D₁ of the circular recess 16 needs only be larger than the diameter D₂ of the removal region 12A by at least 0.02 mm, while the size should be selected depending upon the required specification.

The deep groove 17, the ring-shaped perforated part corresponding to the outer circumference of the circular recess 16 at the bottom should preferably have a sufficiently deep, namely, the thickness t₂ of the substrate 10 at the bottom of the groove 17 is made sufficiently thin. This is because a load upon perforation or misfitting caused by perforation can be reduced in this way, while if the thickness is too small, the fluidity of the resin could be lowered when the disc 10 is formed by injection molding. In order to secure good moldability, the thickness t₂ is preferably at least 0.1 mm, and at most 0.3 mm for the ease of perforation.

FIG. 2 shows a spindle 18 used to rotatably support the disc-shaped substrate 10 in a horizontal plane during spin-coating. The upper end of the spindle 18 is provided with a substrate holding portion 20 having a diameter substantially equal to that of the disc-shaped substrate 10. The holding portion 20 has a ring-shaped raised rim 20A to be fitted with the circular recess 16 and a suction hole (not shown) to hold the disc-shaped substrate 10 by sucking.

According to the embodiment of the method for manufacturing a disc-shaped optical recording medium, the disc-shaped substrate 10 is formed by injection molding, and during the process a pit (bump) pattern to constitute an information recording/reproducing region is transferred on the surface to be coated 10A of the disc-shaped substrate 10, for example, by a stamper 22. At the same time, the circular recess 16 is formed in the center of the non-coated surface l0B.

As described above, the surface having the information recording/reproducing region, in other words, the surface to be coated l0A is provided with a recording layer, a reflective layer and the like by sputtering or vapor deposition. In the following spin-coating step, UV curing resin 11A is applied while the substrate is rotated, so that the resin spreads over the surface. In this way, the light transmitting resin layer 11 is formed.

In this spin-coating step, the disc-shaped substrate 10 is attached to the spindle 18 and secured by suction force, so that the circular recess 16 fits from above to the ring-shaped raised rim 20A provided in the center of the substrate holding portion 20.

As the circular recess 16 and the ring-shaped raised rim 20A are fitted with each other, the disc-shaped substrate 10 is positioned within a horizontal plane. When the spindle 18 is rotated, the disc-shaped substrate 10 is rotated in the horizontal plane around the ring-shaped raised rim 20A.

The surface to be coated 10A of the disc-shaped substrate 10 is spin-coated with the UV curing resin 11A, followed by curing by, UV beam irradiation, and thus the light transmitting resin layer 11 is formed.

Then, as shown in FIG. 1D, the removal region 12A is removed by an ultrasonic press 25 or a simple perforation process to form the central hole 12 for optical disc chucking.

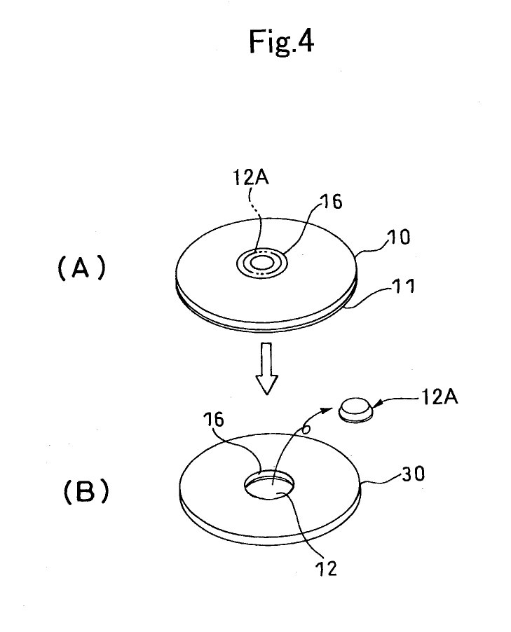

As shown in FIG. 4A, in this state, the circular recess 16 that substantially coincides with the central hole 12 no longer exists in the disc-shaped optical recording medium 30 in a completed state.

Note that in the above embodiment, the positioning and holding of the disc-shaped substrate 10 to the substrate holding portion 20 is carried out by mainly fitting the circular recess 16 and the ring-shaped raised rim 20A with each other, but the invention is not limited to this, and any positioning guide provided at the non-coated surface 10B may be used instead of the circular recess. For example, the recess may be in a shape other than the circular shape.

As described above, according to the invention, when the disc-shaped substrate for a disc-shaped optical recording medium is spin-coated with resin, the disc-shaped substrate may accurately be positioned and stably held.

What is claimed is:

1. A method for manufacturing a disc-shaped optical recording medium, comprising the steps of:
injection-molding a disc-shaped substrate without a central hole for optical recording medium chucking; and
spin-coating a surface on one side of said disc-shaped substrate with resin, wherein
forming a positioning guide on a non-coated surface opposite to said surface to be coated of the disc-shaped substrate in said injection-molding step, and
positioning said disc-shaped substrate by said positioning guide in said spin-coating step.

2. The method for manufacturing a disc-shaped optical recording medium according to claim 1, wherein
in said injection-molding step, a circular recess is formed in the center of said disc-shaped substrate as said positioning guide, said recess having a depth not large enough to penetrate through the disc-shaped substrate in the thickness-wise direction.

3. The method for manufacturing a disc-shaped optical recording medium according to claim 2, wherein
said circular recess has a ring-shaped deep groove along the inner circumference, and
the thickness of the substrate from the bottom of the deep groove to the coated surface of the substrate is in the range from 0.05 mm to 0.3 mm.

4. The method for manufacturing a disc-shaped optical recording medium according to claim 2, further comprising perforating a region to be removed including at least a part of said circular recess in the center of said disc-shaped substrate, thereby forming a central hole for optical recording medium chucking after said spin-coating step.

5. The method for manufacturing a disc-shaped optical recording medium according to claim 3, further comprising perforating a region to be removed including at least a part of said circular recess in the center of said disc-shaped substrate, thereby forming a central hole for optical recording medium chucking after said spin-coating step.

6. The method for manufacturing a disc-shaped optical recording medium according to the claim 4, wherein
said region to be removed has a diameter smaller than that of said circular recess and is present in the region of said circular recess.

7. The method for manufacturing a disc-shaped optical recording medium according to the claim 5, wherein
said region to be removed has a diameter smaller than that of said circular recess and is present in the region of said circular recess.

8. The method for manufacturing a disc-shaped optical recording medium according to claim 1, wherein
until said spin-coating step is completed, said coated surface is continuous from the outer circumference to the center of said disc-shaped substrate, and no central hole is formed.

9. The method for manufacturing a disc-shaped optical recording medium according to claim 2, wherein
until said spin-coating step is completed, said coated surface is continuous from the outer circumference to the center of said disc-shaped substrate, and no central hole is formed.

10. The method for manufacturing a disc-shaped optical recording medium according to claim 3, wherein
until said spin-coating step is completed, said coated surface is continuous from the outer circumference to the center of said disc-shaped substrate, and no central hole is formed.

11. The method for manufacturing a disc-shaped optical recording medium according to claim 4, wherein
until said spin-coating step is completed, said coated surface is continuous from the outer circumference to the center of said disc-shaped substrate, and no central hole is formed.

12. The method for manufacturing a disc-shaped optical recording medium according to claim 5, wherein
until said spin-coating step is completed, said coated surface is continuous from the outer circumference to the center of said disc-shaped substrate, and no central hole is formed.
